(19) United States
(12) Patent Application Publication
(10) Pub. No.: US 2015/0159547 A1
(43) Pub. Date: Jun. 11, 2015

(54) Cross Flow Turbine

(71) Applicants: Pawel Bakula, Leeds (GB); Andrew Day, Huddersfield (GB); James Mawer, Harrogate (GB); James Williams, Bradford (GB)

(72) Inventors: Pawel Bakula, Leeds (GB); Andrew Day, Huddersfield (GB); James Mawer, Harrogate (GB); James Williams, Bradford (GB)

(73) Assignee: BorgWarner Inc., Auburn Hills, MI (US)

(21) Appl. No.: 14/564,700

(22) Filed: Dec. 9, 2014

Related U.S. Application Data
(60) Provisional application No. 61/913,447, filed on Dec. 9, 2013.

(51) Int. Cl. F02B 37/22; F01D 17/14; F02B 37/013; F01D 1/14

(52) U.S. Cl. CPC F02B 37/22; F01D 1/14; F01D 17/141; F02B 37/013

(57) ABSTRACT

A turbocharger (10) with a cross flow turbine (30) where exhaust gas passes through a cross flow turbine wheel (18) on its outer diameter. A cross flow turbine (30) has radial exhaust gas inlet and outlet. Cross flow turbines (30) are suited for variable turbine geometry, including with a single guide vane (44) or multiple guide vanes in the turbine inlet (34) to control variable flow and thus performance of the turbine stage. Cross flow turbines (30) allow reduced size and excellent packaging options, such as a single or dual cross flow turbine wheel (18) between two compressor wheels (12).

### CROSS-REFERENCE TO RELATED APPLICATIONS

This application claims priority to and all the benefits of U.S. Provisional Application No. 61/913,447, filed on Dec. 9, 2013, and entitled “Cross Flow Turbine,” the subject matter of which is incorporated herein by reference.

### BACKGROUND

1. Field of the Disclosure

This disclosure relates to cross flow turbines for turbochargers. More particularly, this disclosure relates to cross flow turbines where exhaust gas passes through a cross flow turbine wheel on its outer diameter.

2. Description of Related Art

Advantages of turbocharging include increased power output, lower fuel consumption, reduced pollutant emissions, and improved transient response. The turbocharging of engines is no longer primarily seen from a high-power performance perspective, but is rather viewed as a means of reducing fuel consumption and environmental pollution on account of lower carbon dioxide (CO₂) emissions. Currently, a primary reason for turbocharging is using exhaust gas energy to reduce fuel consumption and emissions. In turbocharged engines, combustion air is pre-compressed before being supplied to the engine. The engine aspirates the same volume of air-fuel mixture as a naturally aspirated engine, but due to the higher pressure, thus higher density, more air and fuel mass is supplied into a combustion chamber in a controlled manner. Consequently, more fuel can be burned, so that the engine's power output increases relative to the speed and swept volume.

In exhaust gas turbocharging, some of the exhaust gas energy, which would normally be wasted, is used to drive a turbine. The turbine includes a turbine wheel that is mounted on a shaft and is rotatably driven by exhaust gas flow. The turbocharger returns some of this normally wasted exhaust gas energy back into the engine, contributing to the engine's efficiency and saving fuel. A compressor, which is driven by the turbine, draws in filtered ambient air, compresses it, and then supplies it to the engine. The compressor includes a compressor wheel that is mounted on the same shaft so that rotation of the turbine wheel causes rotation of the compressor wheel.

Turbochargers typically include a turbine housing connected to the engine's exhaust manifold, a compressor housing connected to the engine's intake manifold, and often a center housing coupling the turbine and compressor housings together. The turbine housing defines a volute that surrounds the turbine wheel and that receives exhaust gas from the engine. The turbine wheel in the turbine housing is rotatably driven by a controlled inflow of exhaust gas supplied from the exhaust manifold.

Variable turbine geometry (VTG) turbochargers with a radial exhaust gas inlet and an axial exhaust gas outlet allow a turbine flow cross-section leading to the turbine wheel to be varied in accordance with engine operating points. This allows the entire exhaust gas energy to be utilized and the turbine flow cross-section to be set optimally for each operating point. As a result, efficiency of the VTG turbocharger and hence that of the engine can be higher than that achieved with bypass control of a wastegate valve. Variable guide vanes in the turbine have an effect on pressure build-up behavior and, therefore, on the turbocharger power output.

A VTG turbocharger may have a vane ring assembly including a lower vane ring, an upper vane ring (which may include a unison ring), a series of guide vanes pivotally mounted at least partially between the lower vane ring and upper vane ring, and a plurality of spacers positioned between the lower vane ring and upper vane ring.

VTG turbochargers can utilize adjustable guide vanes that are pivotally connected to a lower ring and an upper vane ring, including various possible rings, and/or nozzle wall. These guide vanes are adjusted to control exhaust gas backpressure and turbocharger speed by modulating the exhaust gas flow to the turbine wheel. The guide vanes can be pivoted by vane levers, which can be located above the upper vane ring. Performance and flow to the turbine are influenced by changes of the flow angle to the turbine wheel by pivoting the guide vanes.

### SUMMARY

This disclosure relates to cross flow turbines where exhaust gas passes through a cross flow turbine wheel on its outer diameter. Unlike most turbines for automotive turbochargers that have radial exhaust gas inlet and axial exhaust gas outlet, a cross flow turbine has radial exhaust gas inlet and outlet (radial, radial flow).

Cross flow turbines are well suited for variable turbine geometry, including with the addition of a single guide vane or multiple guide vanes to control variable flow. The performance of the turbine stage can be varied through a guide vane, whose use controls the A/R ratio. A cross flow turbine is less complex and less costly than a VTG turbocharger with a vane ring assembly including a lower vane ring, an upper vane ring, and a series of guide vanes. But the torque generated by a cross flow turbine is typically less than a baseline axi-radial wheel.

The benefits of cross flow turbines also include reduced size and excellent packaging options, such as a cross flow turbine wheel between two compressor wheels.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is a perspective view of a single stage cross flow turbine with a compressor wheel;

FIG. 2 is a diagram of a cross flow turbine arrangement;

FIG. 3 is a perspective view of a cross flow turbine wheel;

FIG. 4 is a diagram of the cross flow turbine wheel in a housing;

FIG. 5 is a diagram of a cross flow turbine with a guide vane;

FIG. 6 is a perspective view of a two-stage turbocharger with a single turbine housing;

FIG. 7 is a partial cut away view of the turbine housing with a two-stage turbocharger showing a dual cross flow turbine wheel between compressor housings;

FIG. 8 is a perspective view of a single cross flow turbine wheel between two compressor wheels on a shaft; and

FIG. 9 is a perspective view of dual cross flow turbine wheels between two compressor wheels on concentric shafts.

### DETAILED DESCRIPTION OF THE EMBODIMENTS

A turbocharger 10 is generally known wherein a compressor wheel 12 in a compressor housing 14 is rotatably driven via a rotatable shaft 16 by a turbine wheel in a turbine housing 20.

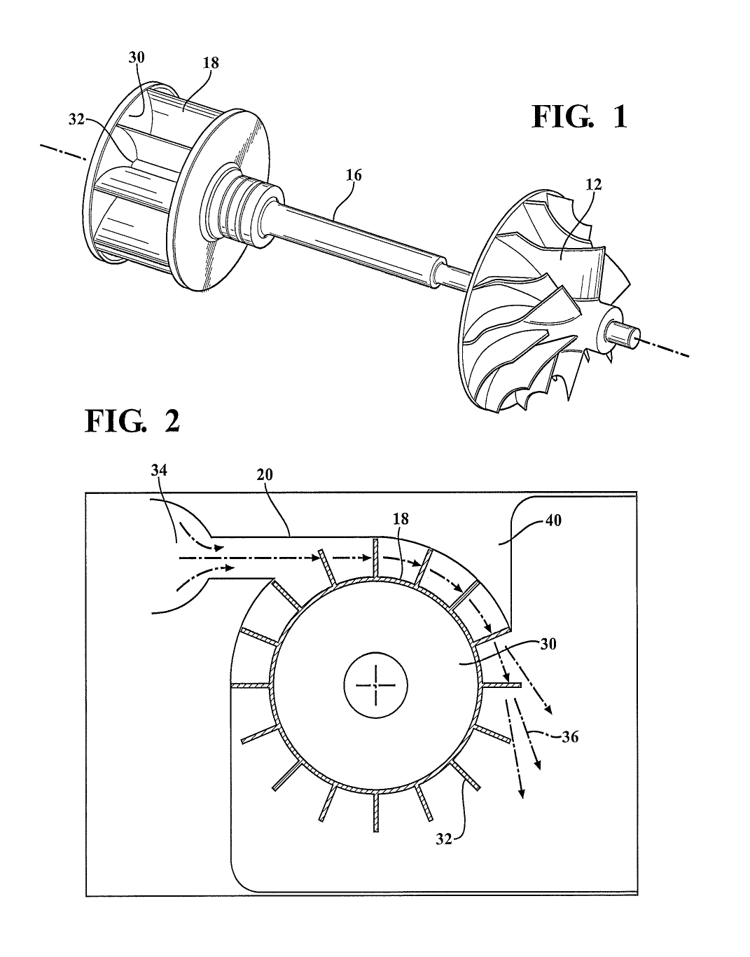

FIG. 1 shows a cross flow turbine 30 with a cross flow turbine wheel 18 with a rotatable shaft 16 connected to a compressor wheel 12 in a single stage package. In a cross flow turbine 30, exhaust gas passes through the cross flow turbine wheel 18 on its outer diameter. The cross flow turbine 30 has radial exhaust gas inlet and radial outlet.

FIG. 2 shows a diagram of a side view of a cross flow turbine 30 with a cross flow turbine wheel 18 having blades 32 extending radially outward. The cross flow turbine wheel 18 is between a turbine inlet 34 where exhaust flow radially enters and a turbine outlet 36 where exhaust gas is radially released from the turbine housing 20. The turbine housing 20 may have various turbine inlets and turbine outlets. As shown, the turbine housing 20 has a rim 40 or equivalent ledge or shelf that curves somewhat corresponding to the outer diameter of the cross flow turbine wheel 18.

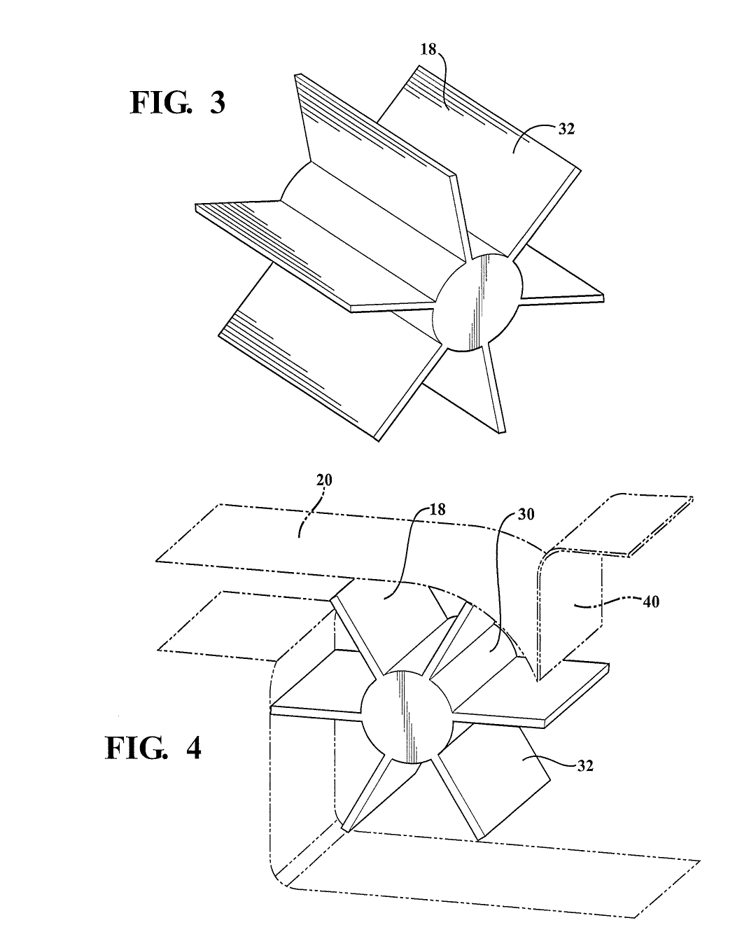

FIG. 3 is a perspective view of a cross flow turbine wheel 18 having six blades 32 extending radially outward. As shown in other figures, the number of blades 32 can change and the radial extension of the blades 32 can slant forward, such as in FIGS. 1, 8 and 9. The cross flow turbine wheel 18 may be similar to a paddle wheel with blades 32 around the circumference. Blade design can be optimized with blade angle, blade area, curvature, feathering, and number of blades 32. The blades 32 in association with the adjacent shape of the turbine housing 20 can also be optimized. FIG. 4 is a diagram of the cross flow turbine wheel 18 in a turbine housing 20 with a rim 40 curving with the outer diameter of the cross flow turbine wheel 18. The rim 40 does not need to be a consistent radius from the center of the cross flow turbine wheel 18.

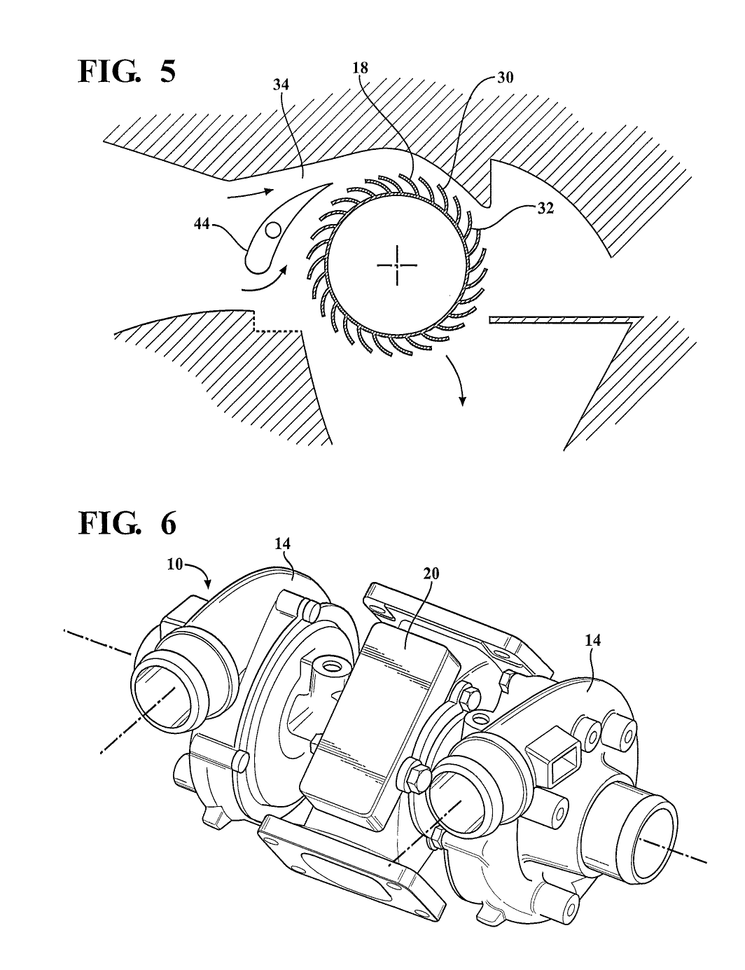

Cross flow turbines 30 are well suited for variable turbine geometry. FIG. 5 is a diagram of a cross flow turbine 30 coupled with VTG with a guide vane 44 in the turbine inlet 34. The guide vane 44 or multiple guide vanes can variably control exhaust gas flow and thus turbine output.

As shown in FIG. 5, a single guide vane 44 in front of the cross flow turbine wheel 18 can change its angle of attack with varying exhaust gas flow speed. The turbine output can be regulated by changing an inflow angle and inflow speed of the exhaust gas flow at a turbine inlet 34. Adjustments of the guide vane 44 can be controlled by various pneumatic or electrical regulators and actuators.

With a guide vane system, the entire exhaust gas flow is directed through the cross flow turbine 30 and can be converted to output, but performance of the turbine stage can be varied though the guide vane(s) 44 changing the flow of exhaust gas and controlling A/R ratio.

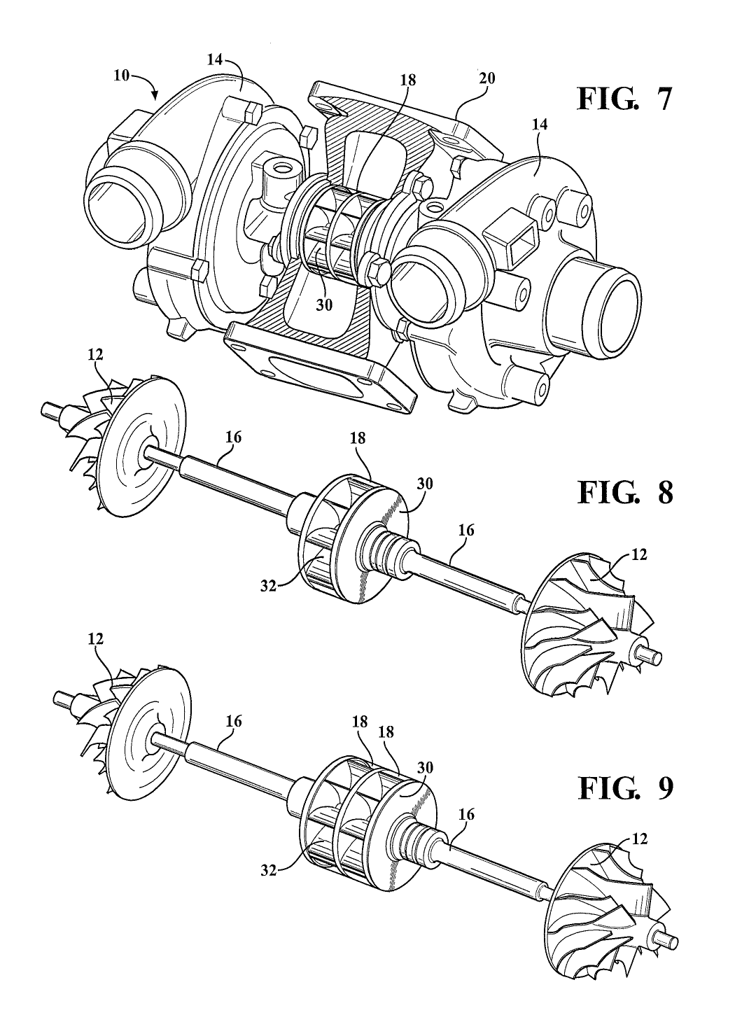

Cross flow turbines 30 provide excellent packaging options. As one packaging option, FIG. 6 shows a single turbine housing 20 for a two-stage turbocharger 10, and FIG. 7 is a partial cut away view showing dual cross flow turbine wheels 18 between compressor housings 14.

As suitable for a two-stage turbocharger with a single turbine housing 20, FIG. 8 shows a single cross flow turbine wheel 18 between two distal compressor wheels 12 on a rotatable shaft 16.

FIG. 9 shows two adjacent cross flow turbine wheels 18 between two distal compressor wheels 12 on two concentric shafts 16. Two cross flow turbine wheels 18 can be mounted in a shared turbine housing 20 with respect to concentric shafts 16 for two-stage packaging with each cross flow turbine wheel 18 corresponding to one shaft 16.

The invention is described in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated in the description.

What is claimed is:

1. Adapted for use with a turbocharger (10), a cross flow turbine (30) where exhaust gas passes through a cross flow turbine wheel (18) on its outer diameter.

2. The cross flow turbine (30) of claim 1 having radial exhaust gas inlet and radial outlet.

3. The cross flow turbine (30) of claim 1 including variable turbine geometry with one or more guide vane (44) to control variable flow of exhaust gas via a turbine inlet (34).

4. The cross flow turbine (30) of claim 3 wherein the variable turbine geometry includes only one guide vane (44) located in the turbine inlet (34) in front of the cross flow turbine wheel (18) that can change its angle of attack to vary exhaust gas flow.

5. The cross flow turbine (30) of claim 1 having the cross flow turbine wheel (18) with a rotatable shaft (16) connected to a compressor wheel (12) in a single stage package.

6. The cross flow turbine (30) of claim 1 wherein the cross flow turbine wheel (18) has blades (32) extending radially outward.

7. The cross flow turbine (30) of claim 6 wherein the blades (32) slant forward.

8. The cross flow turbine (30) of claim 1 in a two-stage turbocharger with a single turbine housing (20) with one cross flow turbine wheel (18) between two compressor wheels (12) on a rotatable shaft (16).

9. The cross flow turbine (30) of claim 1 in a two-stage turbocharger with two adjacent cross flow turbine wheels (18) in a shared turbine housing (20) between two distal compressor wheels (12) on concentric shafts (16).

10. Having a compressor housing (14) with a compressor wheel (12) that is rotatably driven via a rotatable shaft (16), a turbocharger (10) comprising cross flow turbine (30) with a cross flow turbine wheel (18) with blades (32) extending radially outward in a turbine housing (20) for rotating the rotatable shaft (16) where exhaust gas passes through the cross flow turbine wheel (18) on its outer diameter.

11. The turbocharger (10) of claim 10 including variable turbine geometry with one or more guide vane (44) to control variable flow of exhaust gas via a turbine inlet (34).

12. The turbocharger (10) of claim 11 wherein the variable turbine geometry has only one guide vane (44) located in the turbine inlet (34) in front of the cross flow turbine wheel (18) that can change its angle of attack to vary exhaust gas flow.

13. The turbocharger (10) of claim 10 wherein the cross flow turbine (30) has the cross flow turbine wheel (18) with the rotatable shaft (16) connected to the compressor wheel (12) in a single stage package.

14. The turbocharger (10) of claim 10 where the turbocharger (10) is a two-stage turbocharger with one turbine housing (20) with one cross flow turbine wheel (18) between two compressor wheels (12).

15. The turbocharger (10) of claim 10 wherein the cross flow turbine wheel (18) is between a turbine inlet (34) where exhaust flow radially enters and a turbine outlet (36) where exhaust gas is radially released from the turbine housing (20), and the turbine housing (20) has a rim (40) adjacent to the cross flow turbine wheel (18) that curves corresponding to the outer diameter of the cross flow turbine wheel (18).
